(19) United States
(12) Patent Application Publication
(10) Pub. No.: US 2018/0151019 A1
(43) Pub. Date: May 31, 2018

(54) MEDIUM STORAGE BOX AND CASH HANDLING DEVICE

(71) Applicant: Oki Electric Industry Co., Ltd., Tokyo (JP)

(72) Inventors: Masashi KASHIWABUCHI, Tokyo (JP); Hiroshi YOKOKAWA, Tokyo (JP); Takamoto YOKOTE, Tokyo (JP)

(73) Assignee: Oki Electric Industry Co., Ltd., Tokyo (JP)

(21) Appl. No.: 15/575,192

(22) PCT Filed: May 10, 2016
(86) PCT No.: PCT/JP2016/063924

§ 371 Date: Nov. 17, 2017

(30) Foreign Application Priority Data
Jun. 11, 2015 (JP) 2015-118622

(51) Int. Cl. G07D 11/00

(52) U.S. Cl. CPC G07D 11/0012; G07D 11/0045; G07D 2211/00; G07D 11/0018; G07D 11/0048

(57) ABSTRACT

A medium storage box with an internal storage space for storing a medium includes a frame, that is an inner structural body of the medium storage box, a banknote guide that forms the storage space, and a battery that supplies power to desired configuration elements. The banknote guide is attachable to and removable from the frame. The battery is disposed between the frame and the banknote guide. The banknote guide is attached to the frame so as to function as a cover that completely or partially covers one side of the battery.

### TECHNICAL FIELD

The present invention relates to a medium storage box for storing a medium and a cash handling device loaded with such medium storage box.

### RELATED ART

Medium storage boxes (banknote cassettes) that are loaded into a cash handling device such as a cash dispenser (CD) or an automated teller machine (ATM) and in which media such as banknotes are retrievably stored are known. One such related medium storage box includes an internal battery that supplies power to desired configuration elements, and this battery is covered by a dedicated cover (for example, see Japanese Patent Application Laid-Open (JP-A) No. 2006-235987 (FIG. 5)). Accordingly, it is necessary to remove the cover when a battery exchange operation is performed on this related medium storage box.

### SUMMARY OF INVENTION

### Technical Problem

In the related medium storage box, there is an issue that including a dedicated battery cover leads to an increased number of components, which in turn leads to increased per-unit costs.

In consideration of the above circumstances, a principle object of the present invention is to provide a medium storage box having a reduced number of components, and a cash handling device loaded with such medium storage box.

### Solution to Problem

In order to achieve the above object, a first aspect of the present invention is a medium storage box having an internal storage space for storing a medium. The medium storage box includes a frame that is an inner structural body of the medium storage box, a banknote guide that forms the storage space, and a battery. The banknote guide is attachable to and removable from the frame. The battery is disposed between the frame and the banknote guide.

A second aspect of the present invention is a cash handling device for handling cash. The cash handling device includes the medium storage box of the first aspect and a conveyance section. The conveyance section conveys banknotes, serving as the medium, to desired locations, one of which is the medium storage box.

### Advantageous Effects of Invention

The aspects of the present invention enable a medium storage box having a reduced number of components, and a cash handling device loaded with such medium storage box, to be provided.

### BRIEF DESCRIPTION OF THE DRAWINGS

FIG. 1 is a schematic diagram illustrating internal configuration of a cash handling device loaded with medium storage boxes according to a first exemplary embodiment.

FIG. 2 is a perspective cross-section illustrating configuration of a medium storage box according to the first exemplary embodiment.

FIG. 3 is a cross-section illustrating configuration of a medium storage box according to the first exemplary embodiment, as viewed from the side.

FIG. 4 is a cross-section illustrating configuration of a medium storage box according to the first exemplary embodiment, as viewed from above.

FIG. 5A is a diagram illustrating configuration of a rear banknote guide of a medium storage box according to the first exemplary embodiment.

FIG. 5B is a cross-section illustrating configuration of a portion of a rear banknote guide of a medium storage box according to the first exemplary embodiment, as viewed from above.

FIG. 6 is a cross-section illustrating configuration of a medium storage box according to a second exemplary embodiment, as viewed from above.

FIG. 7 is a diagram illustrating configuration of a rear banknote guide according to a modified example.

FIG. 8 is a cross-section illustrating configuration of a medium storage box according to a third exemplary embodiment, as viewed from above.

FIG. 9 is a cross-section illustrating configuration of a medium storage box according to a fourth exemplary embodiment, as viewed from above.

### DESCRIPTION OF EMBODIMENTS

Detailed explanation follows regarding embodiments for implementing the present invention (referred to below as “present exemplary embodiments”), with reference to the drawings. Note that the drawings are merely schematic illustrations to enable sufficient understanding of the present invention. Thus, the present invention is not limited to the illustrated examples. In each of the drawings, common configuration elements and similar configuration elements are appended with the same reference numerals, and duplicate explanation thereof is omitted.

### First Exemplary Embodiment

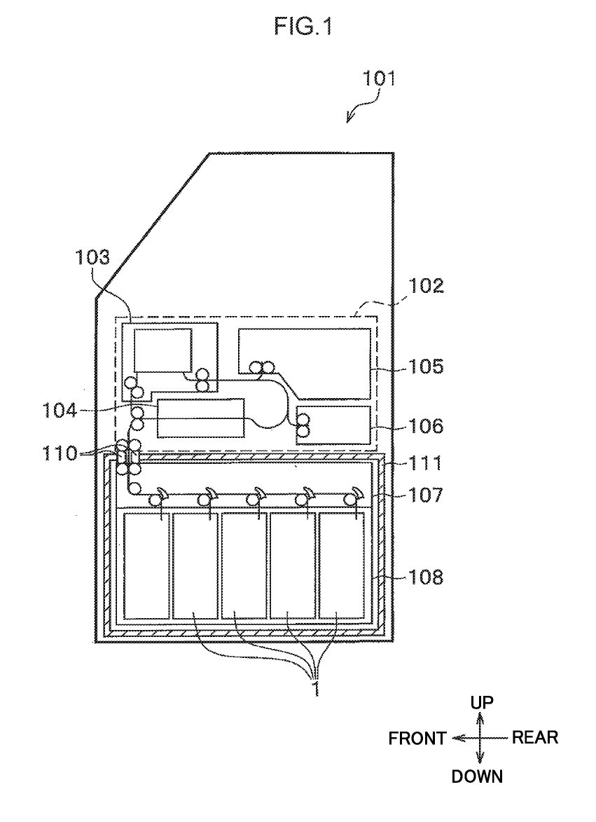

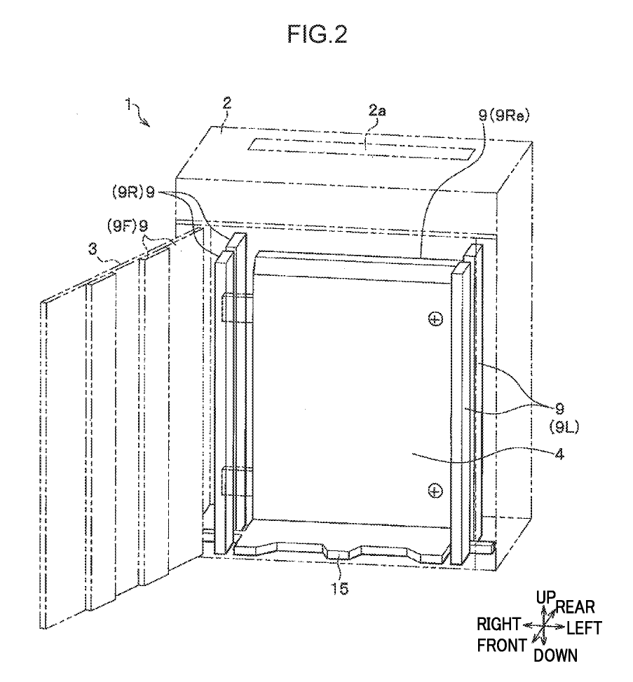

A medium storage box 1 according to the first exemplary embodiment (see FIG. 1 and FIG. 2) is a device that is loaded into a cash handling device such as a cash dispenser (CD) or an automated teller machine (ATM), and in which media such as banknotes are retrievably stored. Herein, explanation envisages a case in which the cash handling device is an ATM, and the media are banknotes.

### Cash Handling Device Configuration

Explanation follows regarding configuration of the cash handling device 101 loaded with medium storage boxes 1 according to the first exemplary embodiment, with reference to FIG. 1. FIG. 1 is a schematic diagram illustrating internal configuration of the cash handling device 101.

As illustrated in FIG. 1, the cash handling device 101 includes a customer interface 103, a differentiation section 104, a temporary holding section 105, a reject box 106, a sorting conveyance section 107, and the medium storage boxes 1.

The customer interface 103 is a configuration element that takes in the medium (banknotes) to the device interior and discharges the medium to the device exterior.

The differentiation section 104 is a configuration element that differentiates the denomination, authenticity, and so on of the medium.

The temporary holding section 105 is a location that temporarily holds the medium.

The reject box 106 is a storage box that stores non-reusable medium.

The sorting conveyance section 107 is a mechanism that sorts and conveys the medium to a desired medium storage box 1.

The medium storage boxes 1 are storage boxes that store reusable medium. The medium storage boxes 1 are configured as units capable of being attached to and removed from the cash handling device 101.

The main functions of the cash handling device 101 are divided between an upper unit 102 that takes in the medium to the device interior and discharges the medium to the device exterior, and a lower unit 108 that houses the medium storage boxes 1. The customer interface 103, the differentiation section 104, the temporary holding section 105, and the reject box 106 are provided in the upper unit 102. The sorting conveyance section 107 and the medium storage boxes 1 are provided in the lower unit 108.

A handover guide 110 is provided between the upper unit 102 and the lower unit 108. The handover guide 110 is a configuration element that guides medium handover between the upper unit 102 and the lower unit 108.

In the cash handling device 101, the periphery of the medium storage boxes 1 is covered by a sturdy safe 111 so as to prevent illicit activity involving the medium storage boxes 1.

### Medium Storage Box Configuration

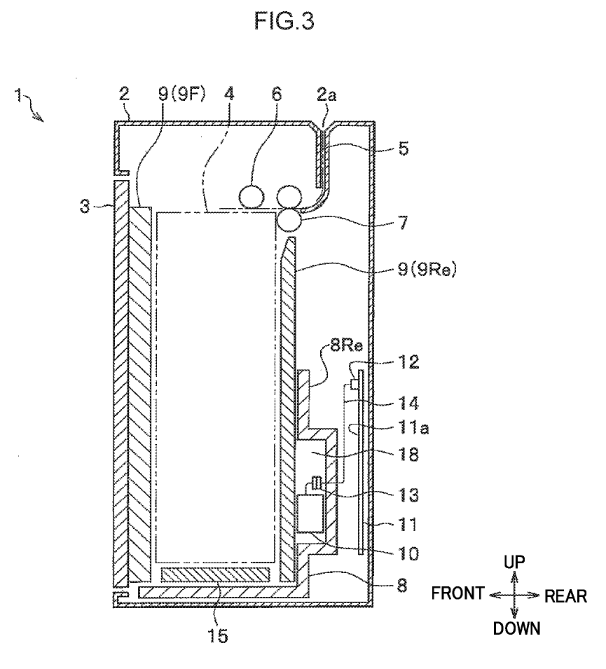

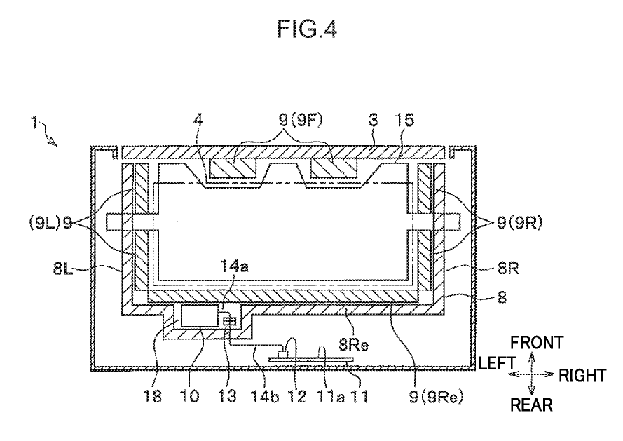

Explanation follows regarding configuration of the medium storage boxes 1, with reference to FIG. 2 to FIG. 4. FIG. 2 is a perspective cross-section illustrating configuration of a medium storage box 1. FIG. 3 is a cross-section illustrating configuration of a medium storage box 1, as viewed from the side. FIG. 4 is a cross-section illustrating configuration of a medium storage box 1, as viewed from above.

Note that, when distinguishing between configuration elements disposed on the front, rear, left, and right from out of plural similar configuration elements, “F” is appended to the reference numeral of the configuration element disposed at the front, “Re” is appended to the reference numeral of the configuration element disposed at the rear, “R” is appended to the reference numeral of the configuration element disposed on the right, and “L” is appended to the reference numeral of the configuration element disposed on the left.

As illustrated in FIG. 2, each medium storage box 1 includes a box shaped casing 2. As viewed from above, a cross-section profile of the casing 2 has a rectangular shape with its longitudinal direction along the left-right direction and its transverse direction along the front-rear direction.

The casing 2 includes a handover port 2a and a door 3. FIG. 2 illustrates configuration of the medium storage box 1 in a state in which the door 3 has been opened.

The handover port 2a is an opening through which banknote handover is performed with a conveyance path of the cash handling device 101 (specifically, the sorting conveyance section 107 illustrated in FIG. 1).

The door 3 is a member that selectively places the interior of the casing 2 in closed state or an open state.

A stage 15 is disposed inside the casing 2. As viewed from above, the stage 15 has a shape in which protrusions are respectively provided at a front edge central portion, a front edge right portion, and a front edge left portion of a rectangular base portion that has its longitudinal direction along the left-right direction and its transverse direction along the front-rear direction (see FIG. 4). The upper face of the stage 15 is formed in a flat face shape, and banknotes are stacked thereon. The stage 15 is configured so as to be capable of being moved in the up-down direction by a non-illustrated drive means, and the stage 15 is lowered as the banknotes are stacked on the upper face of the stage 15.

Four of banknote guides 9 are disposed in the periphery of the stage 15. Specifically, a banknote guide 9F is disposed in front of the stage 15, a banknote guide 9Re is disposed at the rear of the stage 15, a banknote guide 9L is disposed on the left of the stage 15, and a banknote guide 9R is disposed on the right of the stage 15.

Accordingly, the banknote guides 9F, 9Re face longitudinal edges of the stage 15 (namely, longitudinal edges of banknotes stacked on the upper face of the stage 15). Conversely, the banknote guides 9L, 9R face transverse edges of the stage 15 (namely, transverse edges of banknotes stacked on the upper face of the stage 15).

An inner wall-face of each banknote guide 9 that faces the stage 15 is formed in a flat face shape. The inner wall-faces abut the edges of banknotes when banknotes are stacked on the upper face of the stage 15, and function as guide faces that arrange the banknotes. The inner wall-face (guide face) of each banknote guide 9 is disposed so as to extend along the up-down direction (vertical direction).

Of the four banknote guides 9F, 9Re, 9L, 9R, the rear banknote guide 9Re is fixed and installed at a predetermined position inside the casing 2. The banknote guide 9Re thus functions as a reference member for stacking banknotes at a predetermined position in the front-rear direction when stacking the banknotes onto the upper face of the stage 15. In contrast, the other banknote guides 9F, 9L, 9R are configured so as to be movable in a direction toward or a direction away from the respective edge of the stage 15 each faces.

The medium storage box 1 is configured such that banknotes can be stacked in a storage space 4 enclosed by the four banknote guides 9F, 9Re, 9L, 9R. The storage space 4 is formed so as to be a few millimeters larger than the size of the banknotes stored therein. The storage space 4 is smallest when the banknote guides 9F, 9L, 9R have been moved as far toward the inside as possible (when moved along the direction toward the respective edges of the stage 15). The storage space 4 is largest when the banknote guides 9F, 9L, 9R have been moved as far toward the outside as possible (when moved along the direction away from the respective edges of the stage 15).

A front side of the storage space 4 is formed by the banknote guide 9F. The banknote guide 9F is fixed to the door 3, which is provided so as to be openable and closable. The banknote guide 9F (or the door 3) may be configured so as to include a bill stopper. In contrast, the rear side, left side, and right side of the storage space 4 are respectively formed by the banknote guides 9Re, 9L, 9R. The banknote guides 9Re, 9L, 9R are fixed to a frame 8, which configures an inner structural body of the medium storage box 1.

As illustrated in FIG. 3, each medium storage box 1 internally includes a conveyance path 5, the frame 8, a battery 10, and a control board 11.

The conveyance path 5 is a path that links the storage space 4 and the handover port 2a.

The frame 8 configures an inner structural body of the medium storage box 1.

The battery 10 is a power source that supplies power to desired configuration elements such as the control board 11 and non-illustrated actuators. The battery 10 may be a primary cell, a secondary cell, or the like, and may employ a cylindrical cell, a laminated cell, or the like.

The control board 11 is a controller that controls various functions provided in the medium storage box 1.

A feed roller 6 and conveyance rollers 7 are disposed in the periphery of the conveyance path 5.

The feed roller 6 is a roller that feeds out banknotes that have been stacked in the storage space 4 to the conveyance path 5.

The conveyance rollers 7 are rollers that convey banknotes between the storage space 4 and the handover port 2a.

The conveyance rollers 7 are configured such that banknotes can be conveyed in both the direction of from the storage space 4 to the handover port 2a and the direction of from the handover port 2a to the storage space 4. As illustrated in the example of FIG. 3, configuration is such that a pair of the conveyance rollers 7 are in up-down opposition, and the conveyance rollers 7 separate and convey banknotes one sheet at a time. However, configuration may be such that plural pairs of the conveyance rollers 7 are disposed in up-down opposition.

The feed roller 6 and the conveyance rollers 7 are driven by the non-illustrated actuators.

As illustrated in FIG. 4, in the first exemplary embodiment, the frame 8 is formed in a U-shape, as viewed from above. Moreover, as illustrated in FIG. 3 and FIG. 4, a single box shaped recess 18 is formed in the inner wall-face of a rear portion 8Re of the frame 8 formed in a U-shape. The recess 18 functions as a battery space in which the battery 10 is disposed.

In the first exemplary embodiment, configuration is such that the battery 10 and the control board 11 are disposed between the rear banknote guide 9Re and the casing 2 in the medium storage box 1. For example, the battery 10 is housed in the recess 18 formed in the inner wall-face of the rear portion 8Re of the frame 8, and the control board 11 is disposed between the rear portion 8Re of the frame 8 and the casing 2.

In such a medium storage box 1, configuration is such that the battery 10 and the control board 11 are disposed relatively far away from each other. Accordingly, the medium storage box 1 is configured with a relay connector 13 disposed between the battery 10 and the control board 11, and relaying power through the relay connector 13 supplies power from the battery 10 to the control board 11.

Specifically, the relay connector 13 is disposed between the battery 10 and the control board 11. The battery 10 is connected to the relay connector 13 through a cable 14a. The cable 14a and the relay connector 13 are housed in the recess 18 together with the battery 10.

The control board 11 is connected to the relay connector 13 through a cable 14b. The control board 11 is disposed such that a connector mounting face 11a is oriented toward the storage space 4. A board connector 12 for connecting to the battery 10 is provided on the connector mounting face 11a. The cable 14b is connected to the board connector 12.

In the example illustrated in FIG. 3 and FIG. 4, only one battery 10 is housed in the recess 18. However, the recess 18 may be formed such that plural of the batteries 10 can be stored therein. In such case, the batteries 10 would be connected in parallel. The medium storage box 1 is thereby able to supply power to the control board 11 for a relatively long period of time. Note that alternatively, the batteries 10 may be connected in series.

Note that the control board 11 is, for example, provided with communications function to perform wired or wireless communication with a controller of the cash handling device 101, monitoring function to monitor the total amount of banknotes inside the medium storage box 1, function to detect the remaining charge in the battery 10, conveyance-control function to control driving of the non-illustrated actuators and convey banknotes, and the like. For example, when executing transaction processing, the control board 11 establishes communication with the controller of the cash handling device 101 and notifies the controller of the cash handling device 101 of the total amount of banknotes inside the medium storage box 1. In addition, for example when the remaining charge in the battery 10 has become low or when there is zero charge remaining in the battery 10, the control board 11 establishes communication with the controller of the cash handling device 101 and requests replacement of the battery 10.

The control board 11 may also be configured so as to include, for example, anti-theft function such as that described below. For example, the cash handling device 101 may be provided with function to spray liquid (ink) onto banknotes and stain the banknotes during an occurrence of criminal activity (an emergency) in which the cash handling device 101 is damaged and banknotes stored inside stolen. Note that “stain” means a state in which liquid has penetrated into the banknotes. This function is realized, for example, by providing a liquid spraying mechanism to the medium storage box 1. If the criminal activity (emergency) described above were to occur, the liquid spraying mechanism would stain the banknotes stored in the medium storage box 1, thus placing the banknotes in a difficult-to-use state. The liquid spraying mechanism thereby prevents stolen banknotes from being used. Moreover, if the stolen banknotes were to be used, the liquid spraying mechanism facilitates discovery of the use of stolen banknotes and facilitates identification of the person who used the stolen banknotes, thereby deterring the recurrence of the criminal activity (emergency).

### Rear Banknote Guide Configuration

In the first exemplary embodiment, the rear banknote guide 9Re is formed so as to be attachable to and removable from the frame 8. Further, the battery 10 is disposed between the rear portion 8Re of the frame 8 and the rear banknote guide 9Re.

A front face of the rear banknote guide 9Re is formed as a guide face forming the storage space 4. A back face of the rear banknote guide 9Re is formed as a cover face that completely or partially covers one side of the battery 10.

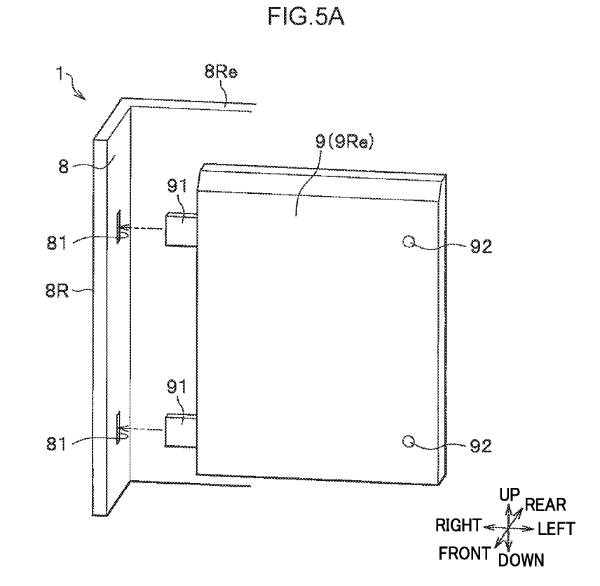

Explanation follows regarding configuration of the rear banknote guide 9Re, with reference to FIG. 5A and FIG. 5B. FIG. 5A and FIG. 5B are diagrams illustrating configuration of the rear banknote guide 9Re. FIG. 5A illustrates configuration of the banknote guide 9Re in a state having been removed from the frame 8, and FIG. 5B illustrates configuration of the banknote guide 9Re when attached to the frame 8. The following explanation envisages a case in which a banknote guide 9Re, in a state having been removed from the frame 8, is attached to the frame 8 by a technician.

As illustrated in FIG. 5A, the rear banknote guide 9Re includes protrusions 91 that are inserted into grooves 81 formed in the frame 8, and insertion-holes 92 into which male screws 19 are inserted. In the first exemplary embodiment, two of the protrusions 91 are formed on the right side of the banknote guide 9Re, and two of the insertion-holes 92 are formed penetrating from an inner wall-face to an outer wall-face of the banknote guide 9Re.

The frame 8 includes the grooves 81 into which the protrusions 91 of the banknote guide 9Re are inserted, and female screw portions 82 (see FIG. 5B) to which the male screws 19 are attached. In the first exemplary embodiment, two of the grooves 81 are formed penetrating from an inner wall-face to an outer wall-face of a right portion 8R of the frame 8 formed in a U-shape so as to correspond to the two protrusions 91 of the banknote guide 9Re. In addition, in the first exemplary embodiment, two of the female screw portions 82 are formed projecting out from the inner wall-face of the rear portion 8Re of the frame 8 formed in a U-shape so as to correspond to the two insertion-holes 92 in the banknote guide 9Re.

In this configuration, when a technician attaches the banknote guide 9Re to the frame 8, first, as illustrated in FIG. 5A, the two protrusions 91 of the banknote guide 9Re are inserted into the two grooves 81 of the frame 8. When this is performed, the protrusions 91 of the banknote guide 9Re and the grooves 81 of the frame 8 function as positioning portions that define the position of the banknote guide 9Re. Accordingly, when this is performed, the banknote guide 9Re is disposed at a predetermined position. As a result, the insertion-holes 92 of the banknote guide 9Re and the female screw portions 82 of the frame 8 adopt an aligned state.

Next, the technician inserts the male screws 19 through the insertion-holes 92 of the banknote guide 9Re so as to attach the male screws 19 to the female screw portions 82 of the frame 8. When this is performed, the insertion-holes 92 of the banknote guide 9Re, the female screw portions 82 of the frame 8, and the male screws 19 function as fixing portions that fix the banknote guide 9Re to the frame 8. Accordingly, when this is performed, the banknote guide 9Re is fixed to the frame 8.

When the banknote guide 9Re has been fixed to the frame 8, the banknote guide 9Re completely or partially covers one side of the battery 10. Namely, by attachment to the frame 8, the banknote guide 9Re functions as a cover that completely or partially covers one side of the battery 10.

Moreover, when this is performed, the banknote guide 9Re covers one side of the relay connector 13 connecting the control board 11 and the battery 10. Namely, by attachment to the frame 8, the banknote guide 9Re functions as a cover that covers one side of the relay connector 13.

In such a medium storage box 1, transaction processing is executed such that, for example, when banknotes are paid into the cash handling device 101, the medium storage box 1 takes in banknotes through the handover port 2a and stores the banknotes in the storage space 4. When this is performed, the banknotes are stacked on the stage 15 in the medium storage box 1 while variation in the positions of the banknotes is kept to within a few millimeters by the four banknote guides 9F, 9Re, 9L, 9R. The medium storage box 1 controls the up-down direction position of the stage 15 in accordance with the number of stored banknotes such that the position (upper face) of the uppermost banknote is kept constant.

During operation, when the remaining charge in the battery 10 has become low or when there is zero charge remaining in the battery 10, the control board 11 of the medium storage box 1 establishes communication with the controller of the cash handling device 101 and requests replacement of the battery 10. In response thereto, the controller of the cash handling device 101 instructs the technician to replace the battery 10 using a freely selected notification means.

When instructed to replace the battery 10, the technician opens the door 3 of the medium storage box 1 and removes banknotes stored inside the medium storage box 1 from the stage 15. The technician then removes the rear banknote guide 9Re from the frame 8. When this is performed, one side of the battery 10 is exposed. A state in which the battery 10 can be removed is thereby adopted.

The technician disconnects the battery 10 from the cable 14a (see FIG. 4), and attaches a new battery 10 to the cable 14a in its place. The technician replaces the old battery 10 with a new battery 10 in this manner.

When the battery 10 has been replaced, the technician attaches the rear banknote guide 9Re to the frame 8. Then, the technician places the banknotes that had been stored inside the medium storage box 1 back on the stage 15, and closes the door 3 of the medium storage box 1. This ends the battery 10 replacement operation.

In this configuration, the medium storage box 1 is configured such that one side of the battery 10 is completely or partially covered by the rear banknote guide 9Re. Namely, the rear banknote guide 9Re has both the function of a guide face that forms the storage space 4 and the function of a cover face that completely or partially covers one side of the battery 10.

When the rear banknote guide 9Re is attached to the frame 8, banknotes can be stacked on the stage 15 in the medium storage box 1 while variation in the positions of the banknotes is kept to within a few millimeters. Moreover, in the medium storage box 1, the battery 10 can be exposed by removing just the rear banknote guide 9Re from the frame 8, thereby making a battery 10 replacement operation possible.

In contrast to the related medium storage box, since the rear banknote guide 9Re is able to function as a cover for the battery 10, a dedicated battery cover can be eliminated from the medium storage box 1. Thus, the number of components in the medium storage box 1 is able to be reduced, thereby enabling per-unit cost to be reduced.

Note that to access the control board 11, after removing the rear banknote guide 9Re from the frame 8, the technician releases the connection between the relay connector 13 and the cable 14b. The technician is then able to access the control board 11 by pulling out the control board 11 from behind the rear portion 8Re of the frame 8.

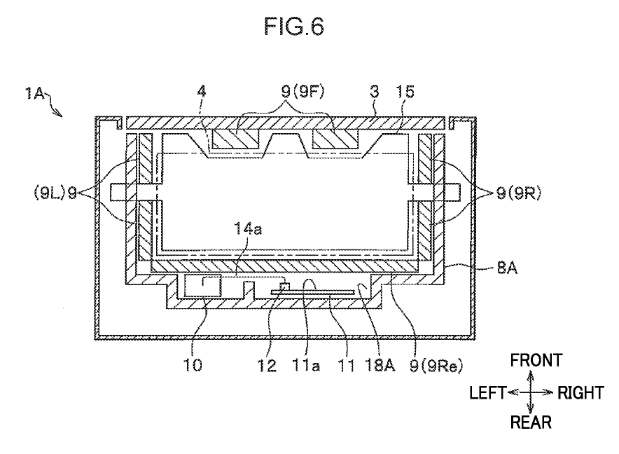

Note that as illustrated in FIG. 7, for example, the medium storage box 1 may be configured such that the rear banknote guide 9Re is split into two banknote guides 9a, 9b.

As explained above, with the medium storage box 1 according to the first exemplary embodiment, the number of components can be reduced.

### Second Exemplary Embodiment

In the medium storage box 1 according to the first exemplary embodiment, configuration is such that the battery 10 and the control board 11 are disposed relatively far away from each other.

In contrast thereto, in a second exemplary embodiment, a medium storage box 1A is provided having a configuration in which the battery 10 and the control board 11 are disposed nearer to each other than in the medium storage box 1 according to the first exemplary embodiment.

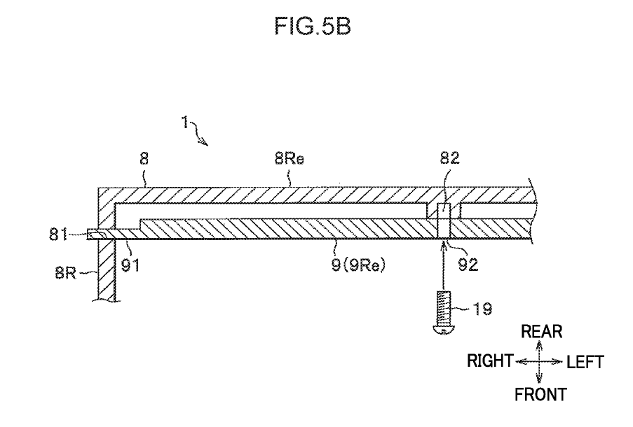

Explanation follows regarding configuration of the medium storage box 1A according to the second exemplary embodiment, with reference to FIG. 6. FIG. 6 is a cross-section illustrating configuration of the medium storage box 1A, as viewed from above.

As illustrated in FIG. 6, the medium storage box 1A according to the second exemplary embodiment differs from the medium storage box 1 according to the first exemplary embodiment in that a recess 18A that is wider than the recess 18 of the first exemplary embodiment is formed in the inner wall-face of a rear portion 8Re of a frame 8A, and in that the battery 10 and the control board 11 are disposed inside the recess 18A.

In the second exemplary embodiment, the battery 10 and the control board 11 are disposed inside the recess 18A formed in the inner wall-face of the rear portion 8Re of the frame 8A. In the medium storage box 1A, configuration is such that the battery 10 and the control board 11 are disposed nearer to each other than in the medium storage box 1 according to the first exemplary embodiment. In contrast to the medium storage box 1 according to the first exemplary embodiment, the medium storage box 1A is therefore able to be configured such that power is directly supplied from the battery 10 to the control board 11 without being relayed through the relay connector 13. Specifically, the medium storage box 1A is able to be configured such that the battery 10 and the board connector 12 are directly connected by the cable 14a.

With this configuration, similarly to in the medium storage box 1 according to the first exemplary embodiment, the dedicated battery cover employed in the related medium storage box can be eliminated from the medium storage box 1A. The number of components in the medium storage box 1A can therefore be reduced similarly to in the medium storage box 1 according to the first exemplary embodiment.

The medium storage box 1A is also configured such that the battery 10 and the board connector 12 are directly connected by the cable 14a. The relay connector 13 and the cable 14b employed in the medium storage box 1 according to the first exemplary embodiment can thus be eliminated from the medium storage box 1A. The number of components in the medium storage box 1A can therefore be reduced to a greater extent than in the medium storage box 1 according to the first exemplary embodiment.

Further, in the medium storage box 1A, the battery 10 and the control board 11 are disposed inside the recess 18A formed in the inner wall-face of the rear portion 8Re of the frame 8A. The medium storage box 1A thus enables the battery 10 and the control board 11 to be exposed by removing just the rear banknote guide 9Re from the frame 8A. Accordingly, the battery 10 of the medium storage box 1A can be replaced by performing a similar operation to that performed on the medium storage box 1 according to the first exemplary embodiment.

Note that in order to access the connector of the control board of the related medium storage box, it is necessary to remove a cover provided to the casing. Accordingly, it is not easy to perform operations such as firmware updates on the related medium storage box.

In contrast thereto, in the medium storage box 1A, the connector mounting face 11a of the control board 11 is made visible to the technician by removing just the rear banknote guide 9Re from the frame 8A. The control board 11 of the medium storage box 1A can therefore be accessed more easily than in the medium storage box 1 according to the first exemplary embodiment. This enables operations such as firmware updates to be easily performed on the medium storage box 1A. Accordingly, with the medium storage box 1A, the ease of operations such as firmware updates is able to be improved.

### Configuration of Rear Banknote Guide According to Modified Example

In the example illustrated in FIG. 6, the medium storage box 1A is configured including one rear banknote guide 9Re. Note that the banknote guide 9Re of the medium storage box 1A has the same configuration as the banknote guide 9Re of the medium storage box 1 illustrated in FIG. 5A. However, for example as illustrated in FIG. 7, the medium storage box 1A may be modified so as to be configured including plural rear banknote guides (in the example illustrated in FIG. 7, two rear banknote guides 9a, 9b). FIG. 7 is a diagram illustrating configuration of the rear banknote guides 9a, 9b according to a modified example.

Herein, explanation is given envisaging a case in which the banknote guide 9a is configured so as to completely or partially cover one side of the control board 11 and in which the banknote guide 9b is configured so as to completely or partially cover one side of the battery 10. In the following, the banknote guide 9a is referred to as the “board-side guide 9a” and the banknote guide 9b is referred to as the “battery-side guide 9b”.

As illustrated in FIG. 7, the board-side guide 9a differs from the banknote guide 9Re illustrated in FIG. 5A in that it has a shorter left-right direction width. The battery-side guide 9b differs from the banknote guide 9Re illustrated in FIG. 5A in that it too has a shorter left-right direction width, and in that the protrusions 91 have been eliminated from its right side and a protrusion 91 is instead formed on its upper side. Note that in the example illustrated in FIG. 7, the left-right direction width of the board-side guide 9a is longer than the left-right direction width of the battery-side guide 9b. However, configuration may be such that the left-right direction width of the battery-side guide 9b is longer than the left-right direction width of the board-side guide 9a.

Further, in the modified example, the medium storage box 1A includes a frame 8T. The frame 8T is a member disposed above the board-side guide 9a and the battery-side guide 9b. The frame 8T includes a groove 81 into which the protrusion 91 of the battery-side guide 9b is inserted. Further, although not illustrated in the drawings, in the modified example, four female screw portions 82 are formed projecting out from the inner wall-face of the rear portion 8Re of the frame 8 formed in a U-shape in the medium storage box 1A so as to correspond to two insertion-holes 92 in the board-side guide 9a and two insertion-holes 92 in the battery-side guide 9b.

In this modified example, when instructed to replace the battery 10, the technician opens the door 3 of the medium storage box 1A, and removes banknotes stored inside the medium storage box 1A from the stage 15. The technician then removes the battery-side guide 9b from the frame 8. When this is performed, one side of the battery 10 is exposed. A state in which the battery 10 can be removed is thereby adopted. The technician then replaces the old battery 10 with a new battery 10, and attaches the battery-side guide 9b to the frame 8. Then, the technician places the banknotes that had been stored inside the medium storage box 1A back on the stage 15, and closes the door 3 of the medium storage box 1A. This ends the battery 10 replacement operation.

Note that after removing the battery-side guide 9b from the frame 8, the technician is able to access the control board 11, and for example, depending on the circumstances, to replace the control board 11 by removing the board-side guide 9a from the frame 8.

In the modified example, configuration is such that the technician is able to efficiently access the battery 10 by the rear banknote guide being split into the board-side guide 9a and the battery-side guide 9b. The reason for this is that the frequency with which a technician accesses the battery 10 is significantly higher than the frequency with which a technician accesses the control board 11.

The modified example enables the battery 10 to be replaced by removing just the battery-side guide 9b from the frame 8. Accordingly, the modified example enables the ease of replacing the battery 10 to be improved.

As explained above, with the medium storage box 1A according to the second exemplary embodiment, the number of components can be reduced similarly to in the medium storage box 1 according to the first exemplary embodiment.

Moreover, the medium storage box 1A enables the number of components to be reduced to a greater extent than in the medium storage box 1 according to the first exemplary embodiment.

### Third Exemplary Embodiment

In the medium storage box 1 according to the first exemplary embodiment, configuration is such that the battery 10 and the control board 11 are disposed between the rear banknote guide 9Re and the casing 2.

In contrast thereto, in a third exemplary embodiment, a medium storage box 1B is provided having a configuration in which an inner wall-face portion of the door 3 is considered to be part of the frame, and the battery 10 and the control board 11 are disposed between the front banknote guide 9F and the door 3.

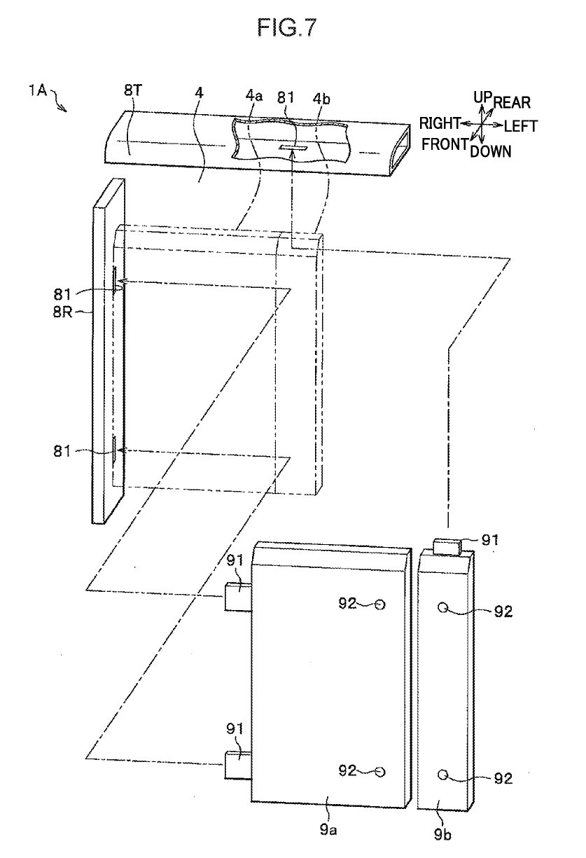

Explanation follows regarding configuration of the medium storage box 1B according to the third exemplary embodiment, with reference to FIG. 8. FIG. 8 is a cross-section illustrating configuration of the medium storage box 1B, as viewed from above.

As illustrated in FIG. 8, the medium storage box 1B according to the third exemplary embodiment differs from the medium storage box 1 according to the first exemplary embodiment in that the battery 10 and the control board 11 are disposed between the front banknote guide 9F and the door 3, and in that it includes a frame 8B in place of the frame 8.

In the third exemplary embodiment, a space 18Ba for housing the battery 10 and a space 18Bb for housing the control board 11 are formed in the inner wall-face of the door 3. Further, the battery 10 and the control board 11 are directly connected by the cable 14a. Note that the space 18Ba for housing the battery 10 and the space 18Bb for housing the control board 11 may be configured as a single combined space.

In addition, the medium storage box 1B includes the frame 8B in place of the frame 8. The frame 8B differs from the frame 8 of the first exemplary embodiment in that it has a shape from which the recess 18 has been eliminated.

With this configuration, similarly to in the medium storage box 1 according to the first exemplary embodiment, the dedicated battery cover employed in the related medium storage box can be eliminated from the medium storage box 1B. The number of components in the medium storage box 1B can therefore be reduced similarly to in the medium storage box 1 according to the first exemplary embodiment.

The medium storage box 1B is also configured such that the battery 10 and the board connector 12 are directly connected by the cable 14a. The relay connector 13 and the cable 14b employed in the medium storage box 1 according to the first exemplary embodiment can thus be eliminated from the medium storage box 1B. The number of components in the medium storage box 1B can therefore be reduced to a greater extent than in the medium storage box 1 according to the first exemplary embodiment.

Further, in the medium storage box 1B, the battery 10 and the control board 11 are disposed on the inner wall-face of the door 3. Accordingly, for example, new function can be easily added by just replacing the door 3. For example, the medium storage box 1B can be easily changed from a configuration that does not have anti-theft function to a configuration having anti-theft function by just replacing the door 3.

As explained above, with the medium storage box 1B according to the third exemplary embodiment, the number of components can be reduced similarly to in the medium storage box 1 according to the first exemplary embodiment.

Moreover, the medium storage box 1B enables the number of components to be reduced to a greater extent than in the medium storage box 1 according to the first exemplary embodiment.

### Fourth Exemplary Embodiment

In a fourth exemplary embodiment, a medium storage box 1C is provided having a configuration in which the battery 10 and the control board 11 are disposed between the left banknote guide 9L (or the right banknote guide 9R) and the casing 2.

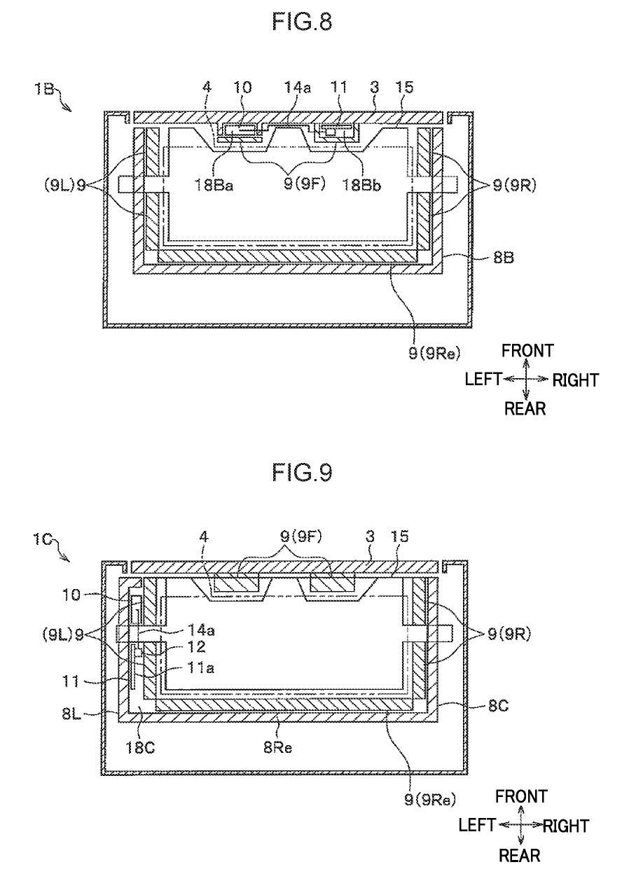

Explanation follows regarding configuration of the medium storage box 1C according to the fourth exemplary embodiment, with reference to FIG. 9. FIG. 9 is a cross-section illustrating configuration of the medium storage box 1C, as viewed from above.

As illustrated in FIG. 9, the medium storage box 1C according to the fourth exemplary embodiment differs from the medium storage box 1 according to the first exemplary embodiment in that it includes a frame 8C in place of the frame 8, and in that its configuration is such that the battery 10 and the control board 11 are disposed between the left banknote guide 9L and the casing 2.

The frame 8C differs from the frame 8 of the first exemplary embodiment in that it has a shape in which the recess 18 has been eliminated from the rear portion 8Re, and a left portion 8L has instead been shifted to the left.

In the fourth exemplary embodiment, a space 18C is formed between the left portion 8L of the frame 8C and the banknote guide 9L due to the left portion 8L of the frame 8C being moved to the left. Further, the battery 10 and the control board 11 are disposed in the space 18C and are directly connected by the cable 14a.

In the example illustrated in FIG. 9, the medium storage box 1C has a configuration in which the battery 10 and the control board 11 are disposed between the left banknote guide 9L and the casing 2. However, the medium storage box 1C may be configured such that the battery 10 and the control board 11 are disposed between the right banknote guide 9R and the casing 2 (namely, with the opposite left-right configuration to the example illustrated in FIG. 9).

With this configuration, similarly to in the medium storage box 1 according to the first exemplary embodiment, the dedicated battery cover employed in the related medium storage box can be eliminated from the medium storage box 1C. The number of components in the medium storage box 1C can therefore be reduced similarly to in the medium storage box 1 according to the first exemplary embodiment.

The medium storage box 1C is also configured such that the battery 10 and the board connector 12 are directly connected by the cable 14a. The relay connector 13 and the cable 14b employed in the medium storage box 1 according to the first exemplary embodiment can thus be eliminated from the medium storage box 1C. The number of components in the medium storage box 1C can therefore be reduced to a greater extent than in the medium storage box 1 according to the first exemplary embodiment.

As explained above, the medium storage box 1C according to the fourth exemplary embodiment enables the number of components thereof to be reduced similarly to in the medium storage box 1 according to the first exemplary embodiment.

Note that the present invention is not limited to the above exemplary embodiments, and various modifications and changes may be implemented within a range not departing from the spirit of the present invention.

For example, the above exemplary embodiments have been explained in detail in order to facilitate understanding of the spirit of the present invention. Thus, the present invention is not necessarily limited to that including all the configuration explained. Some of the configuration of one exemplary embodiment may be added to or replace configuration of another exemplary embodiment of the present invention. Partial configuration may also be omitted from the configuration of an exemplary embodiment of the present invention.

In addition, the medium storage box 1 of the present invention may be employed not only in a cash dispenser (CD) or an automated teller machine (ATM), for example, but also in ticket machines or other cash handling devices.

Further, in the exemplary embodiments described above, the battery 10 and the control board 11 are, for example, disposed clustered together behind one banknote guide 9 out of the four banknote guides 9F, 9Re, 9L, 9R. However, the battery 10 and the control board 11 may be disposed distributed behind plural banknote guides 9 out of the four banknote guides 9F, 9Re, 9L, 9R. Further, plural of each of the battery 10 and the control board 11 may be provided, and these may disposed in freely selected combinations behind one or plural of the banknote guides 9 out of the four banknote guides 9F, 9Re, 9L, 9R.

Further, the medium storage box 1 according to the present invention may, for example, be configured to charge the battery 10 in cases in which the battery 10 is a configured as a secondary cell. Such configuration may, for example, be implemented by employing a known non-contact power supply means configured by a power transmitter and a power receiver. Specifically, such configuration may be implemented by disposing a power transmitter of a non-contact power supply means in the cash handling device and disposing a power receiver of the non-contact power supply means in the medium storage box 1. In this configuration, the power transmitter transmits a high-frequency signal to the power receiver, and the power receiver converts the received high-frequency signal to electric power. Power is thereby supplied in a non-contact manner to the medium storage box 1 in a cash handling device thus configured. However, in a cash handling device with such configuration, only an amount of power that is less than the maximum power consumption amount consumed by the medium storage box 1 can be supplied to the medium storage box 1. Namely, the amount of power supplied by the non-contact power supply means is less than the maximum power consumption amount of the actuators (medium conveyance means). Note that the maximum power consumption amount consumed by the medium storage box 1 is the maximum power consumption amount of the actuators (medium conveyance means) to convey the medium. However, even when the amount of power supplied by the non-contact power supply means is less than the maximum power consumption amount of the actuators (medium conveyance means), by charging the secondary cell with power supplied by the non-contact power supply means when the actuators (medium conveyance means) are not being driven, a cash handling device with such configuration is able to supply a sufficient amount of power to the actuators when the actuators are being driven. Thus, the cash handling device is able to supply an amount of power to the medium storage box 1 sufficient for operation, even when employing a non-contact power supply means that is only able to supply an amount of power that is less than the maximum power consumption amount of the actuators. Further, configuring the battery 10 as a secondary cell enables the replacement interval of the battery 10 to be extended compared to cases in which a primary cell is used.

The disclosure of Japanese Patent Application No. 2015-118622 is incorporated in its entirety by reference herein.

All publications, patent applications, and technical standards mentioned in the present specification are incorporated by reference in the present specification to the same extent as if each individual publication, patent application, or technical standard was specifically and individually indicated to be incorporated by reference.

1. A medium storage box having an internal storage space for storing a medium, the medium storage box comprising:
a frame that is an inner structural body of the medium storage box;
a banknote guide that forms the storage space, the banknote guide being attachable to and removable from the frame; and
a battery disposed between the frame and the banknote guide.

2. The medium storage box of claim 1, wherein:
the banknote guide is attached to the frame so as to function as a cover that completely or partially covers one side of the battery.

3. The medium storage box of claim 1, wherein:
the medium storage box further comprises a controller that controls various functions provided at the medium storage box, and
the battery supplies power to the controller.

4. The medium storage box of claim 3, wherein:
the banknote guide is attached to the frame so as to function as a cover that completely or partially covers one side of the controller.

5. The medium storage box of claim 3, wherein:
the banknote guide is attached to the frame so as to function as a cover that covers one side of a connector connecting the controller with the battery.

6. The medium storage box of claim 3, wherein:
the controller is disposed such that a connector mounting face of the controller is oriented toward the storage space.

7. The medium storage box of claim 1, wherein a front face of the banknote guide is formed as a guide face that forms the storage space, and a back face of the banknote guide is formed as a cover face that completely or partially covers one side of the battery.

8. The medium storage box of claim 1, wherein:
banknote guides are disposed at each of the front, rear, left and right of the storage space; and
the battery is disposed between the frame and the banknote guide, at one or more of the front, rear, left and right of the storage space.

9. The medium storage box of claim 1, wherein:
the battery is a secondary cell,
the medium storage box further comprises:
a medium conveyance means that conveys the medium; and
a power receiver of a non-contact power supply means that charges the secondary cell, and
an amount of power supplied by the non-contact power supply means is less than a maximum power consumption amount of the medium conveyance means.

10. The medium storage box of claim 3, wherein:
the banknote guide is configured by a plurality of portions, one portion of the banknote guide functioning as a cover that completely or partially covers one side of the battery, and another portion of the banknote guide functioning as a cover that completely or partially covers one side of the controller.

11. A cash handling device for handling cash, the cash handling device comprising:
the medium storage box of claim 1; and
a conveyance section that conveys banknotes, serving as the medium, to desired locations, one of which is the medium storage box.
